(19) United States
(12) Patent Application Publication
(10) Pub. No.: US 2025/0237090 A1
(43) Pub. Date: Jul. 24, 2025

(54) ACTUATOR DEVICE FOR ACTUATING A DOOR-LOCK DEVICE ON A HOUSEHOLD APPLIANCE DOOR

(71) Applicant: Elbi International S.p.A., Torino (IT)

(72) Inventor: Andrea SACCOCCI, Torino (IT)

(73) Assignee: Elbi International S.p.A., Torino (IT)

(21) Appl. No.: 19/034,737

(22) Filed: Jan. 23, 2025

(30) Foreign Application Priority Data
Jan. 24, 2024 (IT) 102024000001332

(51) Int. Cl. E05B 47/00; E05B 47/02

(52) U.S. Cl. CPC E05B 47/0012; E05B 47/026; E05B 2047/0016

(57) ABSTRACT

The present invention concerns an actuator device (1) for operating a door-lock device (BP) of a door of a household appliance, such as a washing machine, a dishwasher, and the like, comprising: an electric motor (2) having an output shaft (21); an activation assembly (3) comprising an activator member (31), having a moving pin (33); a slider (4), movable from a rest position to an actuation position (A), having an eccentric shaped opening (41), presenting an internal lateral surface (42), wherein said moving pin (33) is intended to engage with said internal lateral surface (42), and comprising an operating pin (43) intended to engage with said door-lock device (BP), so as to activate it when said slider (4) is in said actuation position; characterized in that said activation assembly (3) comprises a cycloidal reducer (32) coupled to said shaft (21) of said electric motor (2) and said activating member (31), to operate said shaft (21) of said electric motor (2).

### RELATED APPLICATION

This application claims the benefit of priority of Italy Patent Application No. 102024000001332 filed on Jan. 24, 2024, the contents of which are incorporated by reference as if fully set forth herein in their entirety.

### FIELD AND BACKGROUND OF THE INVENTION

The present invention concerns an actuator device for actuating a door-lock device on a household appliance door.

More specifically, the invention concerns an actuator device of the aforementioned type, designed and created in particular to allow the commanded opening of a door equipped with a door-lock, for example, for household appliances, such as washing machines, dryers, ovens, and the like, but which can be used for the automated actuation of any self-locking door.

In the following the description will be directed to a washing machine door, but it is clear that it should not be considered limited to this specific use.

As is well known, in the field of designing actuator devices for household appliances, such as washing machines and dishwashers, there are various technical solutions present on the market. However, these solutions have significant technical issues that limit their effectiveness and applicability.

One of the main problems concerns the use of gearboxes in current systems, which, despite being components suitable for modulating and controlling the movement of the mechanisms, have considerable disadvantages. Firstly, their large footprint is an obstacle to the aesthetics and compact design of household appliances required by the market. The bulk of gearboxes makes it difficult to integrate them into modern, minimalist designs, which require compact and discreet engineering solutions.

Furthermore, the structural complexity of gearboxes, due to their high number of components, leads to a greater probability of failure. Each additional component in a mechanical system not only increases the complexity of the assembly, but increases the likelihood of malfunctions. This factor is particularly critical in domestic environments, where the reliability and durability of the devices are very important.

Another technical issue concerns existing door-lock systems, which often rely on mechanisms based on rotating hooks or latches. Although these systems are functional, they have the significant disadvantage of not being easily automated.

### SUMMARY OF THE INVENTION

In light of the above, it is, therefore, the scope of the present invention to miniaturize the device by providing a solution that adapts effectively to small spaces. This is particularly relevant in household appliances where internal space is limited, and each component must be optimized to maximize efficiency and functionality in a minimal footprint.

A further purpose of the present invention is the optimization of the reduction ratio to guarantee the locking and unlocking times requested by the customer.

It is also the purpose of the present invention to reduce the number of moving components not only simplifies the design, but also reduces the risk of failure.

A further purpose of the present invention is to ensure that the device is versatile and modular, so that it can be easily adapted to a variety of household appliances and lock/unlock systems, thus providing a universal and flexible solution.

Finally, the invention aims at increasing the general reliability of the actuator device, reducing the probability of failures and damages through a simpler and more robust design, which uses fewer components subject to wear or malfunctions.

These and other results are obtained according to the invention with an actuation device for locking or unlocking doors in household appliances equipped with a cycloidal reducer suitable for transferring the movement for locking or unlocking the device itself. This gearbox is intended to reduce the rotation speed of an electric motor, while providing a high reduction ratio in a small footprint.

By means of this motion transfer system, it is possible to transfer the movement both through a linear and rotary mechanism.

The actuator device is able to incorporate a position reading system inside the actuator itself. Alternatively, it can be exploited the signal coming from the door-lock device with which it interfaces. This flexibility in position monitoring allows for control of the locking and unlocking process, improving the safety and operational efficiency of the appliance.

It is therefore specific object of the present invention an actuator device for operating a door-lock device of a door of a household appliance, such as a washing machine, a dishwasher, and the like, comprising: an electric motor having an output shaft; an activation assembly comprising an activator member, having a moving pin; a slider, movable from a rest position to an actuation position, having an eccentric shaped opening, presenting an internal lateral surface, wherein said moving pin is intended to engage with said internal lateral surface, an comprising an operating pin intended to engage with said door-lock device, so as to activate it when said slider is in said actuation position; characterized in that said activation assembly comprises a cycloidal reducer coupled to said shaft of said electric motor and said activating member, to operate said shaft of said electric motor.

Always according to the invention, said actuator device may present a first cycloidal seat, said activator member may have a second cycloidal seat, said cycloidal reducer has a housing, said cycloidal reducer may comprise a first cycloidal disk, configured to fit into said first cycloidal seat, a second cycloidal disk configured to fit into said second cycloidal seat, a bushing, arranged in said housing, and having an eccentric rotation, wherein said bushing is coupled to said shaft of said electric motor.

Still according to the invention, said activator member may be a smooth cylindrical external surface, and, in correspondence with said first cycloidal seat, there may be a smooth cylindrical portion, which faces said external surface.

Advantageously according to the invention, said first cycloidal seat and said smooth cylindrical portion may be obtained at the base of said cylindrical housing.

Further according to the invention, said opening of said slider may have a flat portion, with which said moving pin is in contact in said actuation position, and a curved portion, with which said moving pin is in contact in said rest position.

Preferably according to the invention, said actuator may comprise a containment casing having a slot, wherein said operating pin protrudes from said slot.

Always according to the invention, said actuator may comprise a first portion, having a cylindrical housing for said electric motor, and a first flat half-shell, coupled to said housing, and a second portion, having a second flat half-shell, intended to couple with said first half-shell, wherein said slider is arranged between said first flat half-shell and said second flat half-shell, and wherein said slot is obtained on said second flat half-shell.

### BRIEF DESCRIPTION OF THE SEVERAL VIEWS OF THE DRAWINGS

The present invention will be now described, for illustrative but not limitative purposes, according to its preferred embodiments, with particular reference to the figures of the enclosed drawings, wherein:

FIG. 1 shows an exploded view of an actuator device according to the present invention;

FIG. 2 shows details from the bottom of the actuator device of FIG. 1;

FIG. 3 shows a side sectional view of the actuator device in a rest position;

FIG. 4 is a section from top of FIG. 3;

FIG. 5 shows a side sectional view of the actuator device in an actuation position; and

FIG. 6 is a section from above of FIG. 5.

### DESCRIPTION OF SPECIFIC EMBODIMENTS OF THE INVENTION

In the various figures the similar parts will be indicated with the same reference numbers.

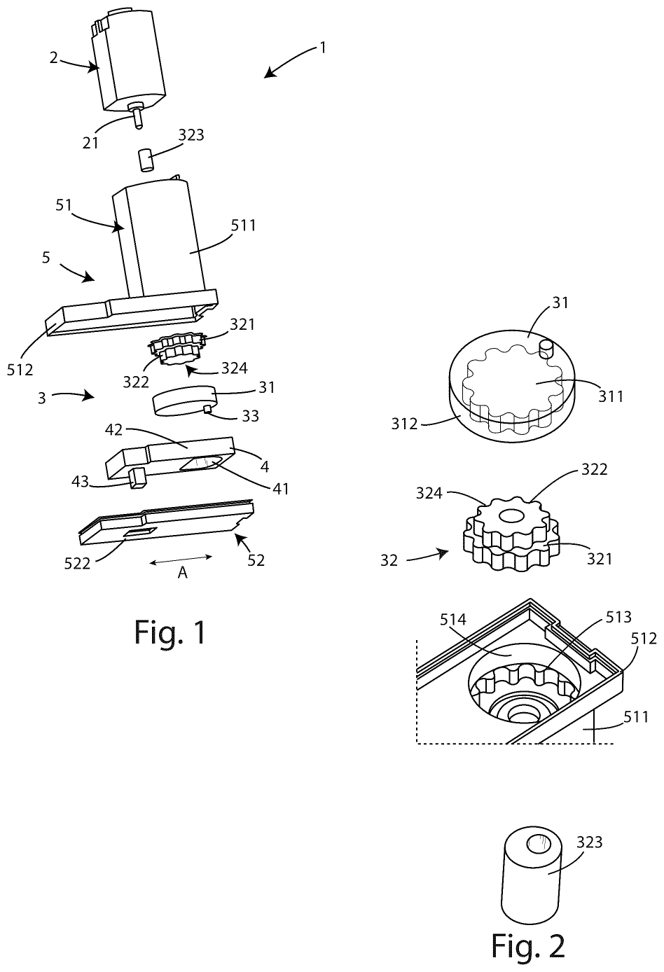

Referring to FIGS. 1 and 2, an actuator device 1 can be seen, designed for locking a door of a household appliance (not shown in the figures), such as a washing machine or a dishwasher.

The actuator device 1 comprises an electric motor 2, an activation assembly 3, a slider 4, and a containment casing 5.

The electric motor 2 is equipped with an output shaft 21. The choice of motor can vary according to specific needs, such as size, power. In particular, in different embodiments, direct or alternating current electric motors, or brushless or stepper electric motors can be provided.

By way of example, the electric motor 2 can be of the direct current (DC) type, generally used for low power applications. Often such motors are controlled using Pulse Width Modulation (PWM), which is a technique for regulating the power supplied. According to this control system, power is provided by varying the pulse width in a periodic signal, thus changing the ratio between the time the signal is active (high) and the time it is inactive (low). Therefore, instead of providing a direct current, the PWM power mode is based on sending a series of high-frequency pulses. The “width” of these pulses determines the actual amount of energy transmitted to the device. This criterion reduces energy loss in the form of heat, providing fine, high-response control.

In some embodiments, a stepper motor can be installed, which offers very precise position control, or a brushless DC (BLDC) motor, which is generally very efficient and long-lasting.

The output shaft 21 of the motor 2 is suitable for transferring the driving force to the other components, to which they are keyed.

The activation assembly 3 comprises an activator member 31, moved by a cycloidal reducer 32.

The activator member 31 has a moving pin 33, which allows, as it will be better described below, the control of the movement of the slider 4.

The activator member 31 has internally a second cycloidal seat 311 and a smooth cylindrical external surface 312. The operation of the second cycloidal seat 311 and the external surface 312 will be better described below.

The activation assembly 3 also comprises a cycloidal reducer 32, coupled to the shaft 21 of the electric motor 2 (as better specified below), and to the activator member 31.

The cycloidal reducer 32 comprises a first cycloidal disk 321 and a second cycloidal disk 322. Furthermore, the cycloidal reducer 32 has a housing 324 and a bushing 323, arranged in the housing 324. The eccentrically rotating bushing 323 is coupled to the shaft 21 of engine 2.

The first cycloidal disk 321, with a larger diameter than the second cycloidal disk 322, however, is configured to fit into a first cycloidal seat 513.

The second cycloidal disk 322 is configured to fit into said second cycloidal seat 311 present on the activator member 31 (see FIG. 2, in which the activator member 31 is shown in transparency, to illustrate the second cycloidal seat 311).

In correspondence with the first cycloidal seat 513, a smooth cylindrical portion 514 is also provided, which faces, when the activator element 31 is mounted, the external surface 312.

A cycloidal gearbox 32 is a mechanical transmission device designed to achieve a reduction in the rotational speed of a drive shaft (the shaft 21 of motor 2), coupled with a corresponding increase in torque. This combination of speed reduction and torque increase makes it particularly effective for applications requiring precise and powerful motion control, as is the case with actuator devices 1.

Cycloidal gearboxes are particularly suitable for applications involving the use of large forces or exposure to heavy loads, as in the case at issue, to prevent the device from blocking.

The slider 4 is configured to move between a rest position and an actuation position (see the double arrow towards A).

The slider 4 has an eccentric opening 41 with a lateral internal surface 42 intended to engage with the moving pin 33.

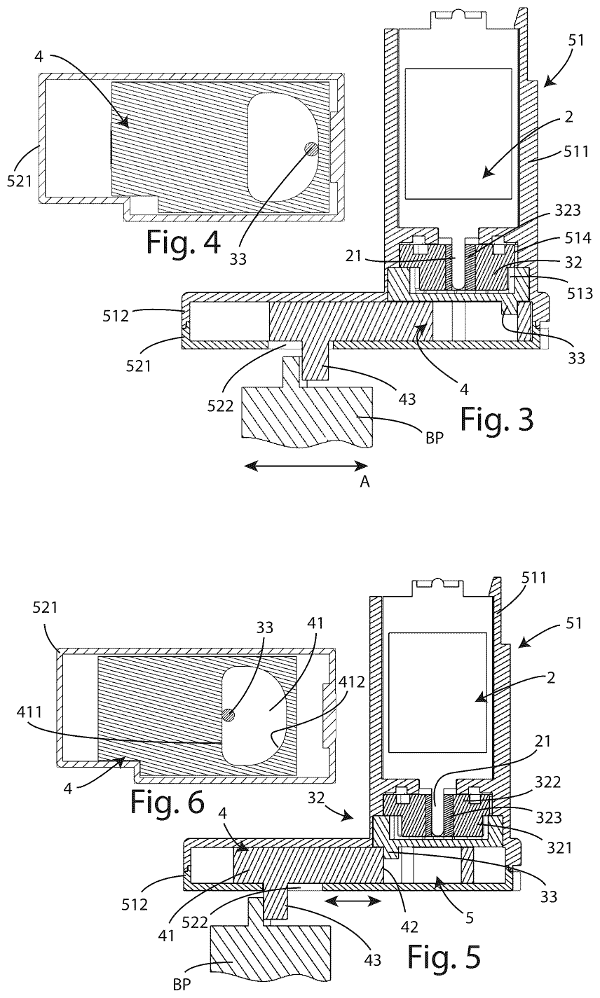

Said slider 4 also comprises an operating pin 43, which engages with the door-lock device BP (see FIG. 3-6) of the household appliance, which interfaces with an actuator (not shown in the figures) for example a locking slider or the like.

In the embodiment shown, the opening 41 of the slider 4 has a flat portion 411 and a curved portion 412, facing said flat portion 411, arranged so as to interact with the moving pin 33 in the different locking and unlocking positions of the door-lock BP of the household appliance.

The opening 41 of the slider 4 can have different alternative embodiments to obtain the same technical effect.

Finally, the containment casing 5 protects and supports the internal components. Said containment casing 5 comprises a first portion 51, having a cylindrical housing 511 for the electric motor 2, and a first flat half-shell 512, and a second portion 52, having a second flat half-shell 521, intended to couple with the first half-shell 512. The coupling can take place using screws, joints, glue and the like.

The slider 4 is arranged in the containment casing 53 obtained between said first 512 and second 521 flat half-shell.

A slot 522 is also provided on the second half-shell 521, which allows the operating pin 43 protruding for interacting with the door block BP of the household appliance, in which said actuator device 1 is installed. It is noted that said

The operation of the actuator device 1 described above is as follows.

Referring to FIGS. 3 and 4, the actuator device 1 can be observed in the rest position, in which the moving pin 33 is in contact with the curved portion 412 of the opening 41.

Upon its activation, the electric motor 2 rotates the output shaft 21.

This movement is transmitted to the activator member 31, which thus rotates, thanks to the cycloidal reducer 32, whose first cycloidal disk 321 and second cycloidal disk 322 interact respectively with said first cycloidal seat 513 of the first portion 51 of said containment casing 5, and said second cycloidal seat 311 of the activator member 31.

In the presence of the cycloidal reducer 32, the movement is modulated to ensure precision and control.

The movement of the activator member 31 causes the movement of the slider 4 between the rest position and the actuation position (see arrows in the direction A). In particular, the moving pin 33 comes into contact with the flat portion 411 of the opening 41 (see FIGS. 5 and 6).

In the locked position, the moving pin 33 being in contact with the flat portion 411 of the opening 41, allowing the operating pin 43 of the slider 4 to engage with the door-lock device BP of the household appliance, ensuring the unlock of the device itself.

When powering the actuator device 1, the cycloidal reducer 32 continues rotating until the activation of a micro internal or external to the actuator device 1, which confirms the complete implementation for the unlock of the door-lock device BP of the door. When the cycloidal reducer 32 is stopped, the actuator device 1 is already ready for a new actuation. To guarantee this condition, the electronics that control the actuator device 1 (and therefore the electric motor 2) must be able to manage a delay on the power supply of the electric motor 2 itself after receiving the actuation signal).

The interaction between the internal lateral surface 42 of the eccentric opening 41 and the moving pin 33 guarantees a smooth and controlled movement of the slider 4.

Furthermore, the containment casing 5 not only protects the internal components, but also contributes to the stability and correct alignment of the system. The slot 522 allows the linear movement of the drive pin 43.

The shape and dimensions of the opening 41 of the slider 4 can also be adapted to optimize the movement and interaction with the moving pin 33.

In other embodiments, the arrangement of the first cycloidal seat 513 and the smooth cylindrical portion 514, adjacent to it, can be arranged in positions, or obtained, instead of on the first portion 51 of the containment casing.

### Advantages

An advantage of the present invention is precision, compactness and low noise. These features are particularly advantageous in domestic environments, where excessive noise can be disruptive and space is often limited. The compactness of the invention allows for easy installation even in household appliances with limited internal spaces, while maintaining precise and silent operation.

A further advantage of the present invention is its high reduction ratio while occupying small spaces. This feature is fundamental as it allows the mechanism to be used in household appliances where space for additional components is minimal. The high reduction ratio also means that the invention can generate a powerful and controlled movement, essential for the effective locking or unlocking of the door, without requiring excessive bulk.

A further significant advantage is its adaptability to different household appliances. The invention is designed to be easily adaptable to different door-lock/unlock device configurations, making it a versatile solution for a wide range of applications. This flexibility allows household appliance manufacturers to implement the invention without having to design specific solutions for each model, reducing production costs and simplifying the assembly process.

The present invention has been described for illustrative but not limitative purposes, according to its preferred embodiments, but it is to be understood that modifications and/or changes can be introduced by those skilled in the art without departing from the relevant scope as defined in the enclosed claims.

1. Actuator device for operating a door-lock device (BP) of a door of a household appliance, such as a washing machine, a dishwasher, and the like, comprising:
an electric motor having an output shaft;
an activation assembly comprising:
an activator member, having a moving pin;
a slider, movable from a rest position to an actuation position (A),
having an eccentric shaped opening, presenting an internal lateral surface,
wherein said moving pin is intended to engage with said internal lateral surface, and
comprising an operating pin intended to engage with said door-lock device (BP), so as to activate it when said slider is in said actuation position;
wherein activation assembly comprises a cycloidal reducer coupled to said shaft of said electric motor and said activating member, to operate said shaft of said electric motor.

2. Actuator device according to claim 1, wherein it presents a first cycloidal seat,
said activator member has a second cycloidal seat
said cycloidal reducer has a housing,
said cycloidal reducer comprises:
a first cycloidal disk, configured to fit into said first cycloidal seat,
a second cycloidal disk configured to fit into said second cycloidal seat,
a bushing, arranged in said housing, and having an eccentric rotation,
wherein said bushing is coupled to said shaft of said electric motor.

3. Actuator device according to claim 2, wherein
said activator member has a smooth cylindrical external surface, and
in that, in correspondence with said first cycloidal seat, there is a smooth cylindrical portion, which faces said external surface.

4. Actuator device according to claim 2, wherein said first cycloidal seat and said smooth cylindrical portion are obtained at the base of said cylindrical housing.

5. Actuator device according to claim 1, wherein said opening of said slider has a flat portion, with which said moving pin is in contact in said actuation position, and a curved portion, with which said moving pin is in contact in said rest position.

6. Actuator device according to claim 1, wherein it comprises a containment casing having a slot, wherein said operating pin protrudes from said slot.

7. Actuator device according to claim 6, wherein it comprises
a first portion, having:
a cylindrical housing for said electric motor, and
a first flat half-shell, coupled to said housing, and
a second portion, having a second flat half-shell, intended to couple with said first half-shell,
wherein said slider is arranged between said first flat half-shell and said second flat half-shell, and
wherein said slot is obtained on said second flat half-shell.

8. Actuator device according to claim 3, wherein said first cycloidal seat and said smooth cylindrical portion are obtained at the base of said cylindrical housing.

9. Actuator device according to claim 2, wherein said opening of said slider has a flat portion, with which said moving pin is in contact in said actuation position, and a curved portion, with which said moving pin is in contact in said rest position.

10. Actuator device according to claim 3, wherein said opening of said slider has a flat portion, with which said moving pin is in contact in said actuation position, and a curved portion, with which said moving pin is in contact in said rest position.

11. Actuator device according to claim 4, wherein said opening of said slider has a flat portion, with which said moving pin is in contact in said actuation position, and a curved portion, with which said moving pin is in contact in said rest position.

12. Actuator device according to claim 2, wherein it comprises a containment casing having a slot, wherein said operating pin protrudes from said slot.

13. Actuator device according to claim 3, wherein it comprises a containment casing having a slot, wherein said operating pin protrudes from said slot.

14. Actuator device according to claim 4, wherein it comprises a containment casing having a slot, wherein said operating pin protrudes from said slot.

15. Actuator device according to claim 5, wherein it comprises a containment casing having a slot, wherein said operating pin protrudes from said slot.
